(19) United States
(12) Patent Application Publication
(10) Pub. No.: US 2003/0033175 A1
(43) Pub. Date: Feb. 13, 2003

(54) Vehicle managing device

(76) Inventors: Koichi Ogura, Tokyo (JP); Kazuhiro Nakamura, Tokyo (JP); Toshiyasu Watanabe, Asaka-shi (JP); Takashi Uehara, Kawagoe-shi (JP); Mamoru Kokubu, Singapore (SG)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/187,270

(22) Filed: Jul. 2, 2002

(30) Foreign Application Priority Data
Jul. 4, 2001 (JP) P2001-203941

(51) Int. Cl. G06F 17/60

(52) U.S. Cl. 705/5; 705/1

(57) ABSTRACT

A vehicle managing device is provided with a control station of a vehicle use shared system in which a user ID number is compared with an ID number registered on an ID terminal owned by the user. The vehicle managing device includes a reservation information storage unit which stores vehicle reservation information of the user so as to relate to the user ID number; a vehicle reservation confirmation unit which confirms a presence of a reservation made by the user on a vehicle the user wishes to use by retrieving the reservation information storage unit using the user ID number transmitted from the vehicle; and a vehicle rental control unit which, if it is determined that the user has made a reservation on another vehicle, cancels the reservation made by the user and instructs rental permission to the vehicle the user wishes to use.

### BACKGROUND OF THE INVENTION

1. Field of the Invention

The present invention relates to a vehicle managing device used in a system of controlling use of a vehicle which is shared by a plurality of users. More specifically, the present invention relates to a vehicle managing device which is suitable in improving users' facility in a lending procedure of the vehicle.

2. Description of Related Art

For a sharing system of a vehicle, various kinds of proposals have been made in order to lend a vehicle, which is generally parked at a parking space called a port, to a plurality of users, in an appropriate manner.

Among such proposals, Japanese Patent No. 2,890,108, for instance, discloses a system in which an information terminal is provided with a port, and a user, either one who has made a reservation and who has not, obtain a driving right certificate from the terminal as a chip card. When the user inserts the chip card into a device provided with a vehicle parked in the port, the door of the vehicle is unlocked and use of the vehicle is permitted.

Also, Japanese Unexamined Patent Application, First Publication No. Hei 6-68095 discloses a system in which a member identification means (such as an electronic card), which is issued to a user, includes all data required by a vehicle lending side, and a determination means is provided with the vehicle to immediately determine if a person inserting the electronic card into the vehicle is entitled to rent the vehicle for a predetermined period of time. After the door of the vehicle is unlocked, the person enters a personal identification number (PIN) to complete a user identification process. In this system, information of a user who has lost his qualification is also stored in a central computer or a computer provided with each vehicle.

Moreover, German Unexamined Patent Application, No. 4301039A1 discloses a system in which the door of a reserved vehicle is unlocked by inserting a personal chip card into an infrared ray hand operating device provided with the vehicle, and a user inserts the personal chip card into a card reader provided inside the vehicle and enters a PIN through a keyboard to complete a user identification process.

In the above-explained vehicle sharing system, the door of a vehicle is unlocked when a user presents an identification means, such as the above-mentioned chip card. However, although the system, in which the door of the vehicle is unlocked by the presentation of the identification means, has an advantage for a user in that the user can have a quick access into the vehicle by avoiding, for instance, rain, there are problems, from the viewpoint of lending vehicles, when a user uses a vehicle other than the one which is reserved by the user, for instance, the reservation of the vehicle is not cancelled and the vehicle cannot be utilized due to the unnecessary reservation information.

Also, in the technique disclosed in the above-mentioned Japanese Patent, No 2,890,108, in particular, there is a problem in that if a reservation of a vehicle is made, the user cannot change the vehicle to another vehicle since the chip card obtained from the terminal is related to the reserved vehicle.

### SUMMARY OF THE INVENTION

The present invention takes into consideration the above-mentioned circumstances, and has as an object to provide a vehicle managing device which appropriately manages a lending operation of a vehicle while maintaining users' facility in a sharing system of the vehicle.

In order to achieve the above object, the present invention provides a vehicle managing device, which is provided with a control station of a vehicle use shared system in which at least permission of a user into a shared vehicle is controlled by setting an identification number of a user, who made a reservation on the shared vehicle, on the shared vehicle, and comparing the identification number of the user with an identification number registered on an identification terminal owned by the user at the shared vehicle side, the vehicle managing device, including: a reservation information storage unit (for instance, the reservation master 17 in an embodiment described later) which stores vehicle reservation information of the user so as to relate to the identification number of the user; a vehicle reservation confirmation unit (for instance, the vehicle reservation confirmation means 101 in an embodiment described later) which confirms a presence of a reservation made by the user on a vehicle the user wishes to use by retrieving the reservation information storage unit using the identification number of the user transmitted from the vehicle the user wishes to use; and a vehicle rental control unit (for instance, the vehicle rental control means 102 in an embodiment described later) which, if it is determined that the user has made a reservation on another vehicle, as a result of a confirmation process carried out by the vehicle reservation confirmation unit, instructs rental permission to the vehicle the user wishes to use and cancels the reservation made by the user.

According to the vehicle managing device having the configuration described above, if a user wishes to use a vehicle other than the one on which the reservation was made by the user, the reservation on the vehicle made by the user is cancelled. Also, since the identification number (ID number) of a user set on a reserved vehicle is compared with an ID number registered on an ID terminal owned by the user at the reserved vehicle side in controlling the rental operation of a vehicle, it becomes possible to prevent the ID number of the user from being set on the reserved vehicle if the user wishes the use of another vehicle and the vehicle reserved by the user is not utilized by the user.

Moreover, the use of a desired vehicle by the user is permitted if the cancellation of the reservation is confirmed.

### BRIEF DESCRIPTION OF THE DRAWINGS

Some of the features and advantages of the invention having been described, others will become apparent from the detailed description which follows, and from the accompanying drawings, in which:

FIG. 1 is a block diagram showing a configuration of an embodiment according to the present invention;

FIG. 2 is a block diagram showing a configuration of a shared vehicle used in the embodiment according to the present invention;

FIG. 3 is a diagram showing a port used for parking the shared vehicle used in the embodiment according to the present invention;

FIG. 4 is a flowchart showing the entire operation in a vehicle use sharing system in which a vehicle managing device according to the embodiment of the present invention is used;

FIG. 5 is a flowchart showing a reservation process in the vehicle use sharing system in which the vehicle managing device according to the embodiment of the present invention is used;

FIG. 6 is a flowchart showing a vehicle rental process in the vehicle use sharing system in which the vehicle managing device according to the embodiment of the present invention is used; and

FIG. 7 is a flowchart showing a vehicle return process in the vehicle use sharing system in which the vehicle managing device according to the embodiment of the present invention is used.

### DETAILED DESCRIPTION OF THE INVENTION

The invention summarized above and defined by the enumerated claims may be better understood by referring to the following detailed description, which should be read with reference to the accompanying diagrams. This detailed description of a particular preferred embodiment, set out below to enable one to build and use one particular implementation of the invention, is not intended to limit the enumerated claims, but to serve as a particular example thereof.

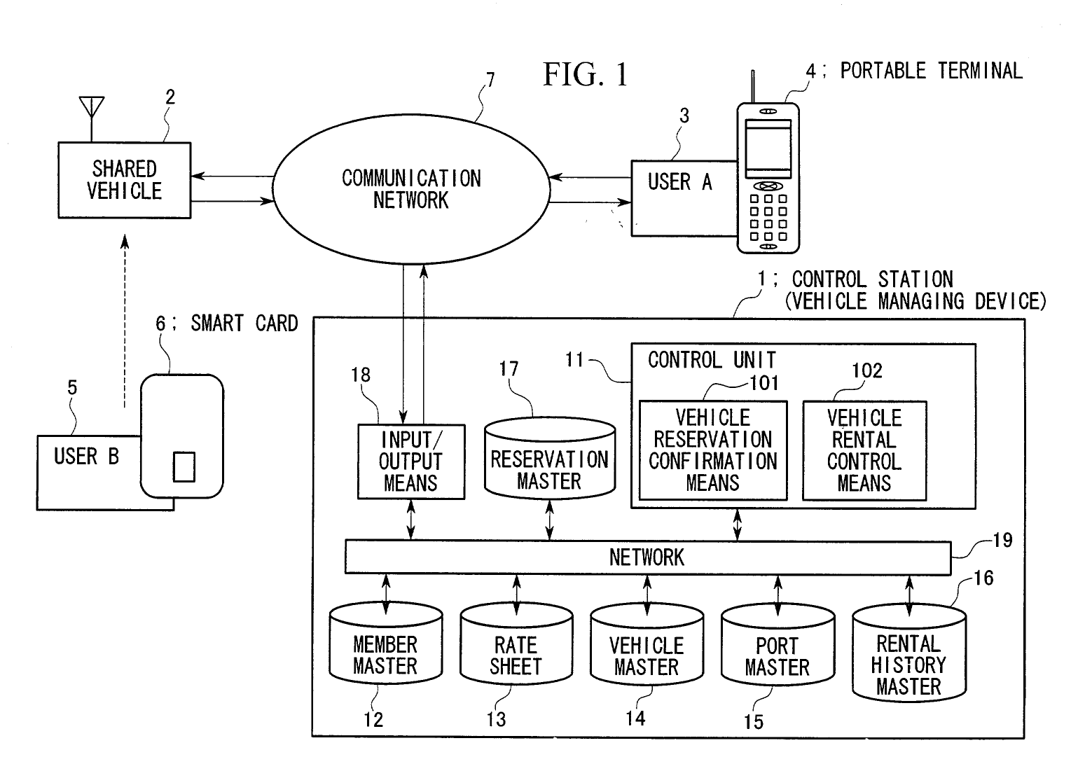

FIG. 1 is a block diagram showing a configuration of an embodiment according to the present invention.

In FIG. 1, the numeral 1 indicates a control station which is a control center of a vehicle use sharing system provided with a vehicle managing device which controls the use, such as a reservation, dispatch, and bill request, of a shared vehicle 2 which is parked at a parking space called a port. According to an embodiment of the present invention, the shared vehicle 2 may be used by two methods. One of the methods is called a “reserved use” in which a user A3 registered as a member by the control station 1 makes a reservation on a vehicle to the control station 1 by assigning information which specifies a vehicle, such as departure/arrival ports, date, time, and car type, via a portable terminal 4. The other method is called a “direct use” in which a user B5 registered as a member by the control station 1 directly uses an available vehicle using a smart card 6 owned by the user.

Also, a communication network 7 is a network for connecting the portable terminal 4 owned by the user A3 to the control station 1, or connecting the shared vehicle 2 to the control station 1. The communication network 7 sends and receives information by a radio communication using, for instance, a wireless application protocol (WAP), or by a wire communication via the Internet or a public circuit network.

Note that more than one shared vehicle 2 can be controlled under the control station 1. Also, the number of the users A3 and B5 is not limited.

Moreover, the portable terminal 4 is a terminal which is capable of connecting to a computer network, such as the Internet, or to a public terminal network. The portable terminal 4 includes a terminal including a mobile phone or a personal handy phone system, which is connected by a wireless communication. Also, the portable terminal 4 is not limited to mobile communication terminals, and includes terminals connected by a wire communication. Further, the above-mentioned terminal using the wire communication or the wireless communication includes a terminal having a simple computer network connection function.

Also, the control station (i.e., a vehicle managing device) 1 includes a control unit 11, a member master 12, a rate sheet 13, a vehicle master 14, a port master 15, a rental history master 16, a reservation master 17, an input/output means 18, and a network 19.

The control unit 11 performs a vehicle management controlling program in a computer system provided with a central processing unit (CPU), and controls the entire operation of the control station 1.

Also, the control unit 11 includes a vehicle reservation confirmation means 101, and a vehicle lending control means 102. The vehicle reservation confirmation means 101 retrieves the reservation master 17, especially when a user uses the shared vehicle 2, using an ID number (a user ID) of a user which is transmitted from the shared vehicle 2 in order to confirm the presence of a reservation made by the user on the shared vehicle 2. The vehicle lending control means 102, if it is not confirmed that a reservation has been made by the user on the shared vehicle 2 as a result of the confirmation process made by the vehicle reservation confirmation means 101, commands the vehicle 2 which has been reserved by the user to cancel the user ID set to make the reservation, and after confirming the cancel of the reservation, issues a lending permission of the shared vehicle 2 the user is about to use. The operation of the control unit 11 will be described later in detail.

The member master 12 is a database for recording registered data of each user registered as a member. In the member master 12, information, such as (1) user ID, (2) address, and (3) usefruct, of each user is recorded.

The rate sheet 13 is a database in which a charging system for the use of the shared vehicle 2 is recorded. In the rate sheet 13, information, such as (1) basic fees, (2) extension fees, and (3) additional/discount fees, is recorded.

The vehicle master 14 is a database in which various information on each of the shared vehicles 2 is recorded in order to manage the shared vehicles 2. In the vehicle master 14, information, such as (1) vehicle number, (2) equipment information including car model (type), equipment, and color, (3) parking position (a parking port), and (4) conditions, is recorded.

The port master 15 is a database in which various information on a port is recorded in order to manage the shared vehicles 2. In the port master 15, information, such as (1) the number of parked vehicles, (2) the number of usable vehicles, and (3) vehicle number of parked vehicles, at each port is recorded.

The rental history master 16 is a database in which rental history of the shared vehicle 2 is recorded. In the rental history master 16, information, such as (1) user ID, (2) vehicle number of (rented) vehicle, (3) rental time, (4) return time, (5) place of rental, (6) place of return, (7) mileage, and (8) amount of fuel consumed, is recorded.

The reservation master 17 is a database in which reservation information is recorded in order to control a reservation made by the user A3 in case of the “reserved use”. In the reservation master 17, information, such as (1) departure port, (2) arrival port, and (3) car type and vehicle number, is recorded so as to relate to the user ID of the user A3.

The input/output means 18 is an interface unit through which information related to the reservation of the vehicle 2 is transmitted between the control station 1 and the portable terminal 4, or through which information related to rental and return of a vehicle, i.e., vehicle control data, is transmitted between the control station 1 and the shared vehicle 2. Note that in this embodiment, the transmittance of the vehicle control data between the control station 1 and the shared vehicle 2 is directly carried out via radio communication.

The network 19 is a network forming a local area network (LAN) to transmit data by connecting the control unit 11, the member master 12, the rate sheet 13, the vehicle master 14, the port master 15, the rental history master 16, the reservation master 17, and the input/output means 18 in the control station 1.

Next, the shared vehicle 2 used in the embodiment according to the present invention will be described with reference to the drawings.

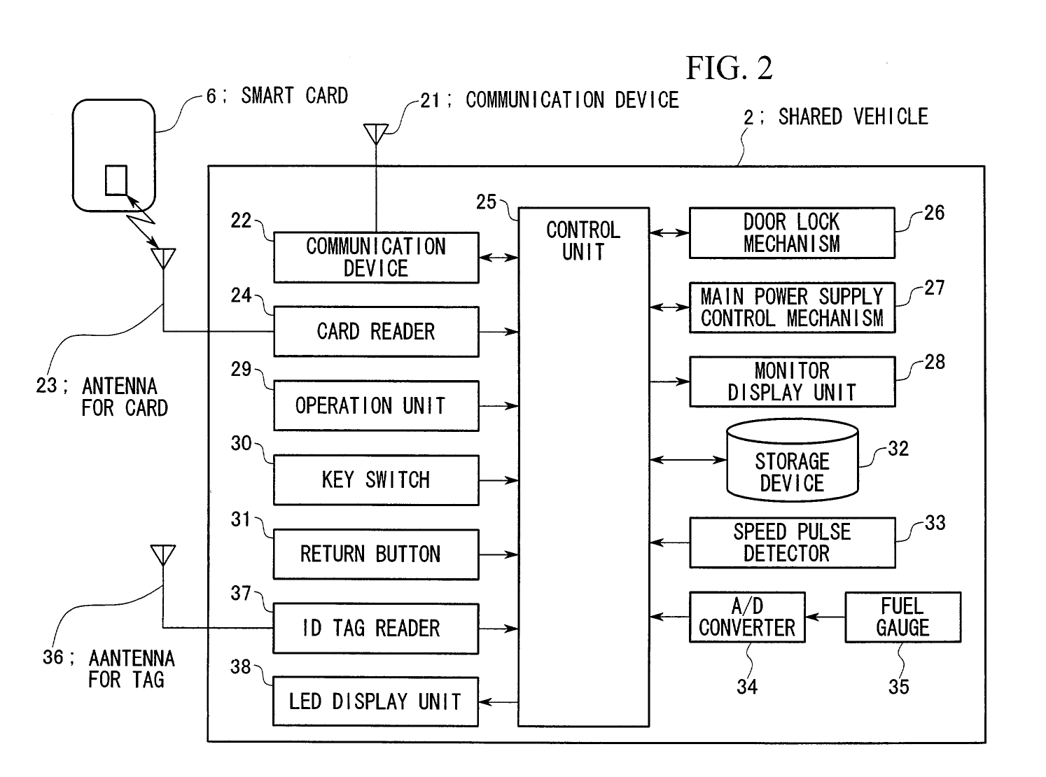

FIG. 2 is a block diagram showing the structure of the shared vehicle 2. In FIG. 2, the shared vehicle 2 includes a communication antenna 21, a communication device 22, an antenna for card 23, a card reader 24, a control unit 25, a door lock mechanism 26, a main power supply control mechanism 27, a monitor display unit 28, an operation unit 29, a key switch 30, a return button 31, a storage device 32, a speed pulse detector 33, an A/D converter 34, a fuel gauge 35, an antenna for tag 36, an ID tag reader 37, and a LED display unit 38.

The shared vehicle 2 is parked within a space having a size of one vehicle called a lot in a parking area called a port. The control station 1 makes a radio communication with the shared vehicle 2 via the communication device 22 connected to the communication antenna 21 to exchange various data.

In the shared vehicle 2, when the user A3 or B5 holds, for instance, a non-contact read and write type smart card 6 to the door antenna for card 23 provided with the shared vehicle 2, a signal read by the card reader 25 is transmitted to the control unit 25 which controls the operation of the shared vehicle 2.

The control unit 25 communicates with the control station 1 by means of radiocommunication via the communication antenna 21 and the communication device 22 in order to transmit the order from the user to use the shared vehicle 2 using the smart card 6, and asks for permission to use the vehicle 2.

Also, the storage device 32 includes a read only memory (ROM) and a random access memory (RAM), and an ID number (vehicle number) assigned to each shared vehicle 2 and the user IDs of users entitled to use the shared vehicle 2 are prestored in the storage device 32. Moreover, the user IDs or PINs input by the users are temporary stored in the storage device 32.

When the user rents the vehicle 2, the user holds the smart card 6 and inputs the user ID so that the control unit 25 compares the input ID with the user ID stored in the storage device 32. If it is determined that both IDs match, the door lock mechanism 26 unlocks the door key.

Also, when the control unit 25 transmits the vehicle number stored in the storage device 32 or the user IDs input by the users to the control station 1, and permission is given to rent the shared vehicle 2 to the user, the PIN of the user is sent to the shared vehicle 2 from the control center 1 to which the permission is asked. After this, if it is confirmed that the PIN input by the user matches the PIN sent from the control station 1 in the control unit 25, the main power supply control mechanism 27 permits the use of an ignition circuit.

The user A3 or B5, upon renting the shared vehicle 2, inputs required information to the control unit 25 via the operation unit 29 in accordance with the instruction displayed on the monitor display unit 25, and then activates the key switch 30 to turn on the ignition of the shared vehicle 2. In this manner, the user can start using the shared vehicle 2. Also, when the user returns the shared vehicle 2 to a port, the user activates the return button 31 to carry out the return process of the vehicle 2 at the port.

Note that the above-mentioned smart card 6 is an ID terminal provided with an IC including a processor, which is capable of reading and writing recorded ID numbers and making a simple decision in the card. In this embodiment of the present invention, the ID terminal used for transmitting the ID number to the shared vehicle 2 may be a non-contacting, or contacting read and write type IC card. Also, the ID terminal is not limited to the non-contacting or contacting read and write type, and can be any terminal which is capable of reading and writing recorded ID numbers, such as magnetic cards and mobile phones including IC chips, as long as the reading device provided with the shared vehicle 2 can read the information contained therein.

When the shared vehicle 2 is in a running mode, a speed pulse signal, which indicates the running state of the shared vehicle 2, is transmitted to the control unit 25 from the speed pulse detector 33. Also, the fuel gauge 35 is connected to the control unit 25 via the A/D converter 34. Accordingly, the control unit 25 can confirm the degree of consumption of the fuel.

The operation for the user to rent the shared vehicle 2 will be described later in detail.

The antenna for tag 36 and the ID tag reader 37 are devices for the shared vehicle 2 parked at the port to identify a lot in the port.

The LED display unit 38 displays a control state of the shared vehicle 2, such as “reserved”, “available”, and “not available”, using, for instance, colored marks or characters, at a position where it can be confirmed by the user from the outside of the shared vehicle 2. Note that the LED display unit 38 can be any display unit as long as it is capable of indicating the control state of the shared vehicle 2 to the users.

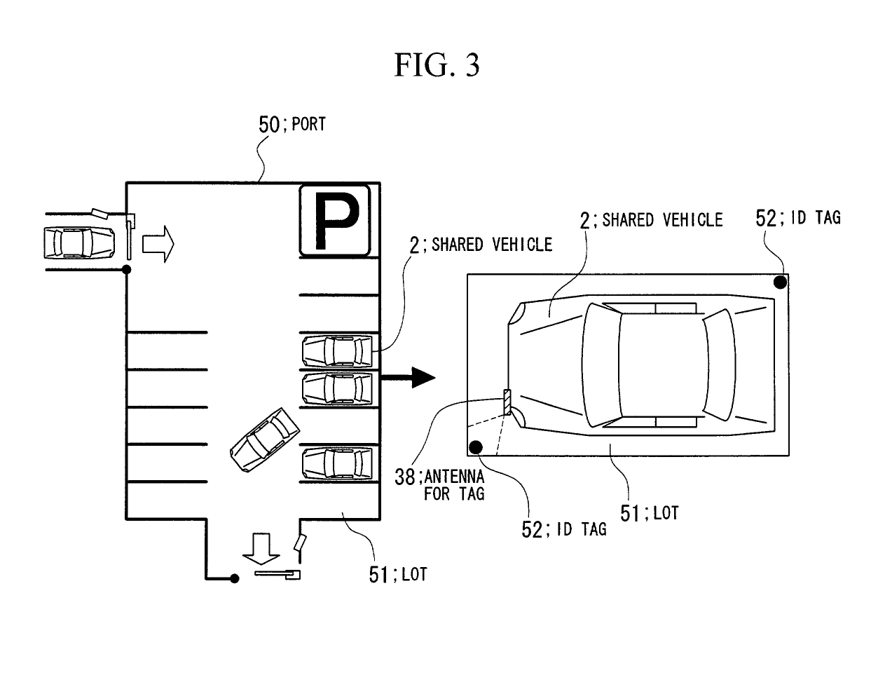

Here, the tag used in the embodiment of the present invention will be explained with reference to FIG. 3. As shown in FIG. 3, a plurality of lots 51 used for parking the shared vehicles 2 are provided with the port 50, and an ID tag 52, which is a device for transmitting an ID number separately assigned to the port 50 or the lots 51, is disposed at each lot 51.

The ID number which is characteristic to the port 50 or each of the lots 51 may be transmitted between the ID tag 52 and the antenna for tag 36 by using any one of the electromagnetic coupling type, the electromagnetic induction type, the microwave type, the electrostatic coupling type, or the optical transmission type system. The shared vehicle 2, on the other hand, reads the signal received via the antenna for tag 36 using the ID tag reader 37 to recognize the position of the port or the lot at which it is parked. Note that the ID tag 52 may be disposed at two diagonal comers of the lot 51 so as to correspond to a front stop and a rear stop of the shared vehicle 2 as shown in FIG. 3, and the antenna for tag 36 may be disposed at either a front corner or a rear comer of the shared vehicle 2 close to the ID tag 52 for the shared vehicle 2 (at a left front corner in FIG. 3).

Also, a mechanism used for recognizing the position of the port or the lot where the shared vehicle 2 is parked is not limited to the ID tag 52, and a transmitter receiver used in an electronic toll correction (ETC) system or a position detection means using a global positioning system (GPS) may also be utilized.

Next, a vehicle lending operation in the vehicle use shared system in which a vehicle managing device according to the embodiment of the present invention is employed will be explained with reference to the drawings.

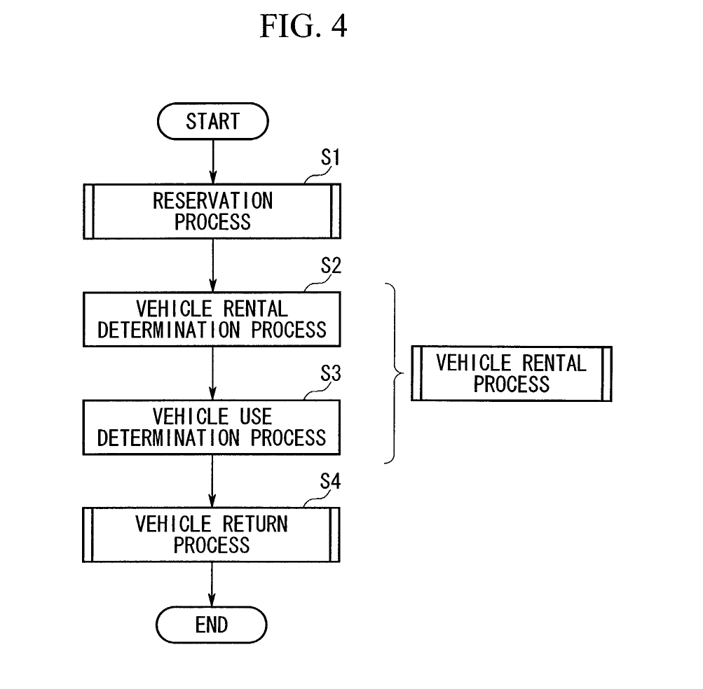

First, the overall flow of the processes in the vehicle use shared system will be explained using a flowchart shown in FIG. 4.

When the user A3 makes a reservation of the shared vehicle 3, the user A3 accesses to the control station 1 using the portable terminal 4 via the communication network 7, such as the Internet, to carry out a procedure for the reservation process (step S1). If a right to use the shared vehicle 2 is secured, the user actually goes to the port where the shared vehicle 2 is parked, and presents his user ID by holding the smart card 6 to the antenna for card 23 of the shared vehicle 2 to which the reservation was made by the user.

Also, for the case where the user B5 uses the shared vehicle 2 without making a reservation, the reservation process (in step S1) is not carried out by the control station 1. In such a case, the user directly goes to the port where the shared vehicle 2 is parked, and presents his user ID by holding the smart card 6 to the antenna for card 23 of the shared vehicle 2 the user desires to use.

When the user presents his user ID, the shared vehicle 2 determines if the user is allowed access to the vehicle, and carries out a vehicle rental process by communicating with the control station 1 to lend the vehicle to the user.

The vehicle rental process includes a vehicle rental determination process (step S2), which is mainly carried out by the control station 1 side, and a vehicle use determination process (step S3), which is mainly carried out by the shared vehicle 2 side.

In this embodiment, the vehicle rental determination process (step S2) includes a process for confirming the user ID assigned to a user, and the control unit 25 of the shared vehicle 2, when the user A3 or B5 makes access to the shared vehicle 2 using the smart card 6, reads the user ID recorded in the smart card 6 by means of the card reader 24 in order to determine whether the access to the vehicle 2 can be permitted to the user. Also, the control unit 25 makes an inquiry of the user ID to the control station 1 via the communication device 22 and the communication antenna 21.

The control unit 11 of the control station 1, on the other hand, when an inquiry of the user ID from the shared vehicle 2 the user wishes to use is received, retrieves the reservation master 17 using the received user ID to confirm the reservation on the shared vehicle 2 made by the user. If the reservation on the shared vehicle 2 made by the user is not confirmed, the control unit 11 orders a cancellation of the user ID, which is set to make the reservation, to the vehicle on which the reservation was made by the user. Also, if the cancellation of the reservation on the vehicle made by the user is confirmed, the control unit 1 sends a PIN, which is set for the user, to the shared vehicle 2 the user wishes to use as a rental permission.

If the access to the vehicle is given, the user inputs the PIN assigned to the user via the operation unit 29 of the shared vehicle 2, and the shared vehicle 2 carries out a vehicle use determination step (step S3). In this embodiment, the vehicle use determination process is a process for confirming the PIN given to the user. When the user A3 or B5 inputs the PIN through the operation unit 29, the control unit 25 of the shared vehicle 2 determines whether the input PIN matches with the PIN which was given to the user A3 or B5 in advance and sent from the control station 1. If it is determined that the two PINs match with each other, the control unit 25 of the shared vehicle 2 outputs a signal for permitting starting the engine to the main power source control mechanism 27 so that the user can start the engine of the shared vehicle 2 using the key switch 30 to utilize the vehicle 2.

When the user, to whom the permission to use the shared vehicle 2 is given as a result of the vehicle rental determination process and the vehicle use determination process, completes the use of the shared vehicle 2, the user carries out a vehicle return process (step S4) so that the control station 1 can obtain return information which is used for charging fees. In this manner, the operation in the vehicle use shared system according to this embodiment of the present invention is completed. Note that the return information means information which is necessary for calculating fees for using the shared vehicle 2, such as the time of return, the mileage, and the remaining amount of fuel.

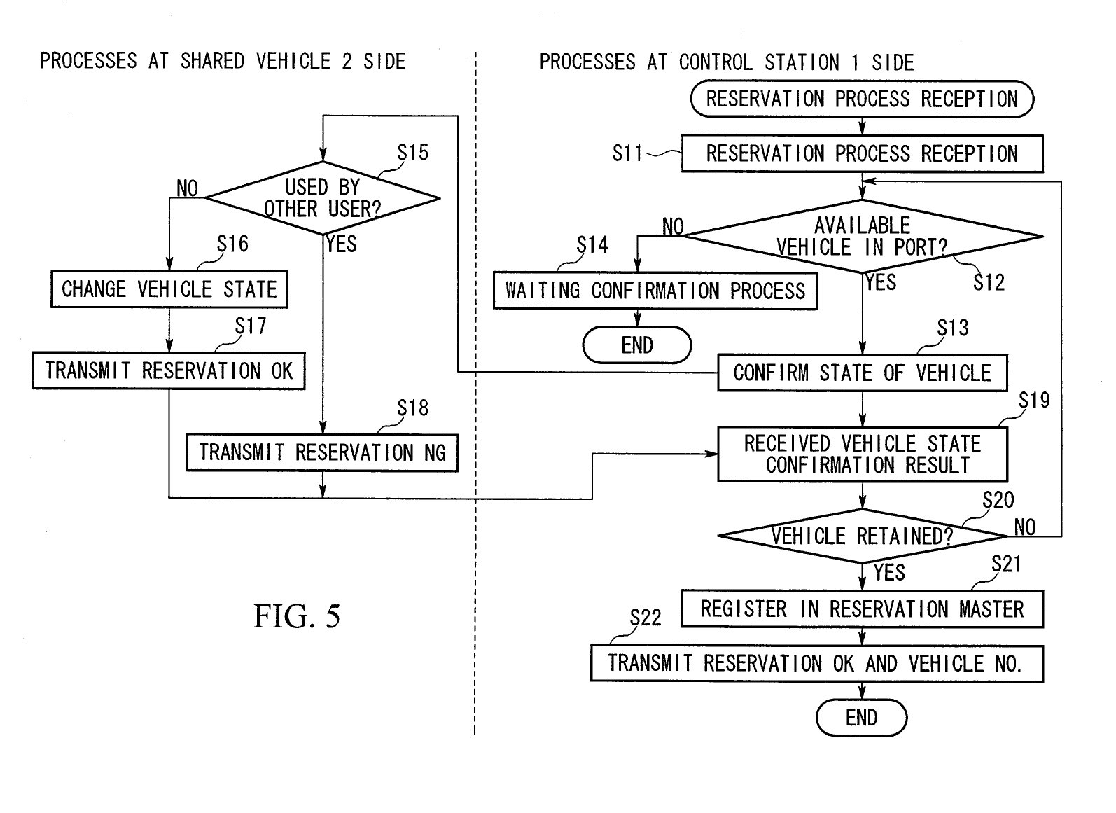

Next, the above-mentioned reservation process will be further described in detail using the flowchart shown in FIG. 5.

First, when the user A3 accesses the control station 1 via the communication network 7 using the portable terminal 4, the control unit 11 of the control station 1 asks the user A3 to present the user's authentication via the portable terminal 4, and then asks the user A3 to input reservation conditions to receive information necessary for a reservation process (step S11). In this embodiment, the reservation conditions mean information necessary for selecting a shared vehicle 2 to be rented, such as a port of departure, a port of arrival, date of use, time of use. and desired type of the vehicle. Note that the type of the vehicle means the classification used for distinguishing vehicles, such as car model (car make), engine, transmission (e.g., AT/MT), type of power transmission function, for instance, two wheel/four wheel drive, availability of equipment, for instance, sunroof, and color of the vehicle.

Next, the control unit 11 determines if there is an available vehicle at a port of departure (step S 12).

In step S12, if it is determined that there is an available vehicle at the port of departure (i.e., “YES” in step S12), a signal for confirming the reservation is sent to the corresponding shared vehicle 2 (step S13).

In step S12, if it is determined that there is no available vehicle at the port of departure (i.e., “NO” in step S12), the control unit 11 sends a message of “reservation NG (no good)” to the user A3 via the portable terminal 4, and displays a reservation waiting confirmation screen to ask the user A3 whether he wishes to wait for an available vehicle or stop making the reservation and terminates the reservation process (step S14).

Also, corresponding to the above-mentioned step S13, the control unit 25 of the shared vehicle 2, which has received the signal for confirming the reservation from the control station 1, determines whether the vehicle is currently used by another user by, for instance “the direct use” without making the reservation on the vehicle via the control station 1 (step S15).

In step S15, if it is determined that the shared vehicle 2 is not used by another user (i.e., “NO” in step S15), the state of the vehicle is changed so that the permission for renting the vehicle is only given to the user ID of the user A3, who wishes to make the reservation, among the user IDs stored in the storage device 32 (step S16), and a signal of “reservation OK” is transmitted to the control station 1 (step S17).

Also, in step S15, if it is determined that the shared vehicle 2 is used by another user (i.e., “YES” in step S15), a signal of “reservation NG” is transmitted to the control station 1 (step S18).

On the other hand, the control unit 11 receives a signal of “reservation OK” or “reservation NG” from the shared vehicle 2 (step S19), and determines whether the shared vehicle 2 has been retained (step S20).

In step S20, if it is determined that the shared vehicle 2 has not been retained (i.e., “NO” in step S20), the process returns to step S12 and repeats the above-explained process.

Also, in step S20, if it is determined that the shared vehicle 2 has been retained (i.e., “YES” in step S20), the user ID of the user A3 who wishes to make the reservation is related to the vehicle number of the retained shared vehicle 2, and this is recorded in the reservation master 17 together with the above-mentioned reservation conditions (step S21).

Also, a message of “reservation OK” and the vehicle number of the reserved vehicle are sent to the portable terminal 4 of the user A3 who wishes to make the reservation (step S22), and the reservation process is terminated.

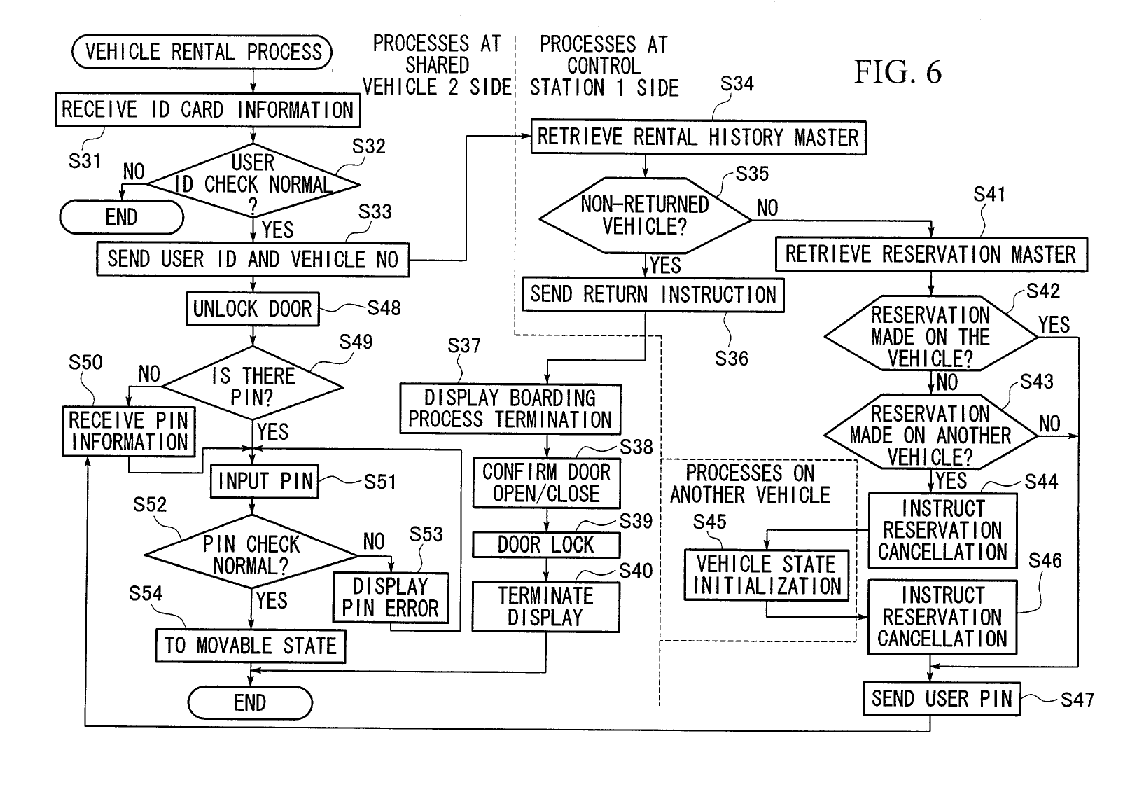

Next, the above-mentioned vehicle rental process including the vehicle rental determination process and the vehicle use determination process will be described further in detail using the flowchart shown in FIG. 6.

First, when the user A3 or B5 makes an access to the shared vehicle 2 using the smart card 6, the control unit 25 of the shared vehicle 2 reads the user ID recorded in the smart card 6 by means of the card reader 24 (step S31), and compares it with the user ID stored in the storing device 32 to which the permission of renting the vehicle has been given in order to determine whether the rental permission has been given to the user who wishes to use the shared vehicle 2 (step S32).

In step S32, if it is determined that the rental permission has not been given to the user who wishes to use the shared vehicle 2 (i.e., “NO” in step S32), the vehicle rental process is terminated.

Also, in step S32, if it is determined that the rental permission has been given to the user who wishes to use the shared vehicle 2 (i.e., “YES” in step S32), the control unit 25 of the shared vehicle 2 transmits the user ID and the vehicle number to the control station 1 via the communication device 22 and the communication antenna 21 (step S33).

Next, when the control unit 25 of the shared vehicle 2, the use of which has been requested by the user A3 or B5, transmits the user ID of the user, the control unit 11 of the control station 1 retrieves the rental history master 16 using the user ID of the user (step S34), and confirms whether there is a non-returned vehicle used by the user (step S35).

In step S35, if it is confirmed that there is a non-returned vehicle used by the user (i.e., “YES” in step S35), the control unit 11 of the control station 1 transmits a message to the shared vehicle 2 asking for the user to return the non-returned vehicle (step S36).

Also, the control unit 25 of the shared vehicle 2, which has received the message asking for the user to return the non-returned vehicle from the control unit 11 of the control station 1, displays a message on the monitor display unit 28 indicating “boarding process is already made” for the user (step S37).

When it is confirmed that the user, who confirmed the message, got off the vehicle and closed the door (step S38), the door of the vehicle is locked (step S39), and the indication on the monitor display unit 28 is turned off (step S40) to terminate the vehicle rental process.

In step S35, on the other hand, if it is determined that there is no vehicle not returned by the user (i.e., “NO” in step S35), the vehicle reservation confirmation means 101 in the control unit 11 retrieves the reservation master 17 using the received user ID of the user (step S41) in order to confirm whether there is a reservation made by the user on the shared vehicle 2 the user wishes to use (step S42).

In step S42, if the reservation made by the user on the shared vehicle 2 the user has requested to use is not confirmed (i.e., “NO” in step S42), the vehicle reservation confirmation means 101 in the control unit 11 determines whether the user has made a reservation for another shared vehicle 2 (step S43).

In step S43, if it is determined that the user has made a reservation for another shared vehicle 2 (i.e., “YES” in step S43), the vehicle rental control means 102 in the control unit 11 orders the other shared vehicle 2 on which the reservation has been made to cancel the reservation (step S44).

The control unit 25 of the other shared vehicle 2 to which the cancellation of the reservation has been ordered by the control unit 11 of the control station 1 carries out an initialization process to eliminate the user ID of the user which has been stored in the storage device 32 in order to cancel the reservation setting made by the use (step S45).

The vehicle rental control means 102 in the control unit 11, when a signal of indicating the completion of reservation cancellation is received from the shared vehicle 2 on which the reservation was made by the user (step S46) and the cancellation of the reservation is confirmed, renews the reservation master 17 and transmits a PIN assigned to the user to the shared vehicle 2 the user wishes to use as a signal for indicating rental permission (step S47).

Also, in step S42, if the reservation made by the user on the shared vehicle 2 the user has requested to use is confirmed (i.e., “YES” in step S42), or if it is confirmed that the user has not made a reservation on another shared vehicle 2 in step S43 (i.e., “NO” in step S43), the process proceeds to step S47 and the vehicle rental control means 102 in the control unit 11 transmits a PIN assigned to the user as a rental permission signal to the shared vehicle 2 the user wishes to use.

Note that although the PIN assigned to the user is transmitted as a rental permission signal to the shared vehicle 2 the user wishes to use for the first time if the reservation on the shared vehicle 2 made by the user is confirmed (i.e., “YES” in step S42) in the above-mentioned step S42, it is possible to set a PIN for the shared vehicle 2 when the reservation is made. In this manner, the rental process may be smoothly carried out when the user uses the shared vehicle 2 to which the reservation has been made by the user since both the user ID of the user and the PIN are available at the shared vehicle side.

Also, in step S33, the control unit 25 of the shared vehicle 2 which transmitted the user ID and the vehicle number to the control station 1 via the communication device 22 and the communication antenna 21, unlocks the door of the shared vehicle 2 after the user ID and the vehicle number are transmitted to the control station 1 in order to allow the user to access into the vehicle (step S48).

Then, it is determined if the PIN of the user, which corresponds to the user ID input by the user using the smart card 6 in step S31, is stored in the storage device 32 (step S49).

In step S49, if it is determined that the PIN of the user is not stored in the storage device 32 (i.e., “NO” in step S49), the PIN of the user is received from the control unit 11 of the control station 1 via the communication device 22 and the communication antenna 21 (step S50).

After the door lock of the shared vehicle 2 is unlocked, the user who has been allowed to access into the vehicle is asked to input the PIN assigned to the user through the operation unit 29 provided with the shared vehicle 2 (step S51).

Also, in step S49, if it is determined that the PIN of the user is stored in the storage device 32 (i.e., “YES” in step S49), the process proceeds to step S51 without carrying out any other processes, and the user who has been permitted to have an access into the vehicle through the unlocked door is asked to input the PIN assigned to the user through the operation unit 29 provided with the shared vehicle 2.

Then, when the PIN is input, the control unit 25 of the shared vehicle 2 compares it with the PIN stored in the storage device 32 in order to determine whether the PIN input by the user is correct or incorrect (step S52).

In step S52, if it is determined that the PIN input by the user is incorrect (i.e., “NO” in step S52), a message, such as “a wrong PIN”, is displayed for the user on the monitor display unit 28 (step S53), and the process returns to step S51 to repeat the above-explained operation.

In step S52, if it is determined that the PIN input by the user is correct (i.e., “YES” in step S52), on the other hand, the control unit 25 of the shared vehicle 2 outputs a signal indicating engine start permission to the main power source control mechanism 27 so that the shared vehicle 2 enters into a movable state (step S54), and terminates the vehicle rental process.

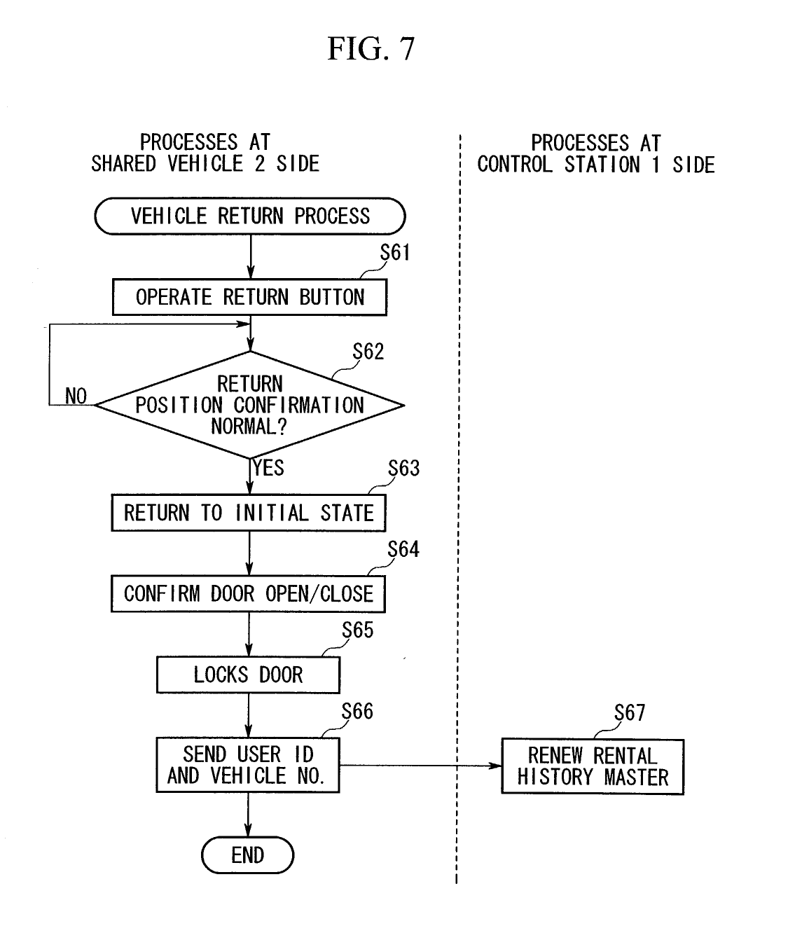

Next, the above-mentioned vehicle return process will be described further in detail using the flowchart shown in FIG. 7.

The control unit 25 of the shared vehicle 2, when the return button 31 is pushed or activated (step S61), determines if the returning position confirmation is working (i.e., if the parking detection by the antenna for tag 36 and the ID tag reader 37 is turned ON) (step S62) in order to determine whether the shared vehicle 2 has arrived at, in this case, the lot 51 of the port 51 at the place of destination, and waits for the vehicle 2 to arrive at the lot 51 of the port 50 and the returning position confirmation becomes normal (i.e., waits for the detection of the ID tag 52) (i.e., “NO” in step S62).

In step S62, when the shared vehicle 2 arrives at the lot 51 of the port 50 and the detection of the ID tag 52 becomes possible, the parking detection operation using the antenna for tag 36 and the ID tag reader 37 is turned ON and the returning position confirmation becomes normal (i.e., “YES” in step S62). At this time, the control unit 25 of the shared vehicle 2 obtains information, such as time or return, speed pulse counter value, and an amount of remaining fuel, and resets the shared vehicle 2 to return to its initial state (step S63).

After this, if it is confirmed that the user A3 or B5 who has used the shared vehicle 2 opens the door to get off the vehicle and closes the door (step S64), the door of the vehicle 2 is locked (step S65).

Then, the control unit 25 of the shared vehicle 2 transmits the return information together with the user ID of the user and the vehicle number to the control station 1 via the communication device 22 and the communication antenna 21 (step S66), and terminates the vehicle return process. Note that the return information means information, such as the time of return, mileage, and the amount of remaining fuel, obtained in step S63.

When the return information is transmitted from the shared vehicle 2 (step S66), on the other hand, the control unit 11 of the control station 1 writes information, such as the user ID of the user A3 or B5 who has returned the vehicle 2, the time of return, mileage, and the amount of remaining (or consumed) fuel of the vehicle 2, into a rental list recorded in the rental history master 16 to renew the contents recorded in the rental history master 16 (step S67). Note that the fee for using the shared vehicle 2 which is calculated based on information, such as mileage, used hours, and consumed fuel, is recorded in a section assigned to the user in the rental history master 16.

As explained above, according to the vehicle managing device of the embodiment of the present invention, since the door of the shared vehicle 2 is unlocked by the processes carried out by the shared vehicle 2 side if the user ID is confirmed via the smart card 6 owned by the user, not only is the advantage obtained for a user in that the user can have a quick access into the vehicle by avoiding, for instance, rain, but also the problem associated with this type of system is solved, from the viewpoint of lending vehicles, that when a user uses a vehicle other than the one which has been reserved by the user, for instance, the reservation on the vehicle is not cancelled and the vehicle cannot be utilized due to the unnecessary reservation information. Accordingly, an excellent effect in which shared vehicles are maintained to be in a usable state all the time can be obtained according to the present invention.

Having thus described several exemplary embodiments of the invention, it will be apparent that various alterations, modifications, and improvements will readily occur to those skilled in the art. Such alterations, modifications, and improvements, though not expressly described above, are nonetheless intended and implied to be within the spirit and scope of the invention. Accordingly, the invention is limited and defined only by the following claims and equivalents thereto.

What is claimed is:

1. A vehicle managing device, which is provided with a control station of a vehicle use shared system in which at least permission of a user to enter into a shared vehicle is controlled by setting an identification number of a user, who made a reservation for said shared vehicle, on said shared vehicle, and comparing said identification number of said user with an identification number registered on an identification terminal owned by said user at said shared vehicle side, said vehicle managing device, comprising:
a reservation information storage unit which stores vehicle reservation information of said user so as to relate to said identification number of said user;
a vehicle reservation confirmation unit which confirms a presence of a reservation made by said user on a vehicle said user wishes to use by retrieving said reservation information storage unit using said identification number of said user transmitted from said vehicle said user wishes to use; and
a vehicle rental control unit which, if it is determined that said user has made a reservation on another vehicle, as a result of a confirmation process carried out by said vehicle reservation confirmation unit, cancels the reservation made by said user and instructs rental permission to said vehicle said user wishes to use.

2. A vehicle managing device according to claim 1, wherein
said vehicle rental control unit, if it is determined that said user has not made a reservation on another vehicle, as a result of the confirmation process carried out by said vehicle reservation confirmation unit, instructs rental permission to said vehicle said user wishes to use.

3. A vehicle managing device according to claim 1, wherein
said vehicle rental control unit, if it is determined that said user has not returned a vehicle said user previously used, instructs no rental permission to said vehicle said user wishes to use.
